(19) United States
(12) Patent Application Publication
(10) Pub. No.: US 2025/0052998 A1
(43) Pub. Date: Feb. 13, 2025

(54) PHOSPHOR WHEEL AND IMAGE PROJECTION DEVICE COMPRISING THE SAME

(71) Applicant: LG ELECTRONICS INC., Seoul (KR)

(72) Inventors: Gunyoung HONG, Seoul (KR); Younggil YOO, Seoul (KR); Minsung KIM, Seoul (KR); Kyungpil KIM, Seoul (KR); Bokyung KANG, Seoul (KR); Seungmi BAEK, Seoul (KR)

(73) Assignee: LG ELECTRONICS INC., Seoul (KR)

(21) Appl. No.: 18/722,265

(22) PCT Filed: Dec. 21, 2021
(86) PCT No.: PCT/KR2021/019476

§ 371 Date: Jun. 20, 2024

(51) Int. Cl. G02B 26/00; G03B 21/20

(52) U.S. Cl. CPC G02B 26/008; G03B 21/204

(57) ABSTRACT

An image projection device and an image projection device comprising the same are disclosed. A phosphor wheel according to an embodiment of the present disclosure comprises a substrate, a reflective light-emission layer disposed on the substrate, and a phosphor layer disposed on the reflective light-emission layer, wherein the reflective light-emission layer includes resin and a phosphor having a higher heat conductivity than that of the resin. Accordingly, high-efficiency light output and color purity improvement are possible.

### BACKGROUND

### 1. Field

The present disclosure relates to a phosphor wheel and an image projection device comprising the same. More particularly, the present disclosure relates to a phosphor wheel and an image projection device comprising the same with improved light conversion efficiency and thermal conductivity.

### 2. Description of the Related Art

An image projection device is a device that projects an image onto a surface, particularly, on a screen or the like.

Such an image projection device can output light of a plurality of colors using a phosphor wheel coated with a phosphor.

Meanwhile, as the resolution of images increases, there has been a growing demand for high-efficiency light output at the time of projecting an image.

As such, in order to improve the conversion efficiency of a phosphor used in a phosphor wheel, research has been conducted to increase the thickness or content of the phosphor.

However, when the thickness or content of a phosphor is increased, the increase in brightness is limited due to heat dissipation constraints.

Meanwhile, Chinese Patent Publication No. 203489181 (hereinafter referred to as “related art document”), which is hereby incorporated by reference, discloses a color wheel, a light source system of the color wheel, and a projection system.

In the related art document, a ceramic substrate (130), a reflective layer (120), and a phosphor powder layer (110) are sequentially stacked on a metal wheel (140).

However, as for the related art document, when the thickness of a phosphor is increased in order to improve conversion efficiency of the phosphor, it causes a heat increase to thereby lead to a reliability issue.

### SUMMARY

The present disclosure describes a phosphor wheel with improved light conversion efficiency and thermal conductivity, and an image projection device including the phosphor wheel.

The present disclosure also describes a phosphor wheel with high-efficiency light output and improved color purity, and an image projection device including the phosphor wheel.

According to an aspect of the subject matter described in this application, a phosphor wheel includes a substrate, a reflective luminous layer disposed on the substrate, and a phosphor layer disposed on the reflective luminous layer, wherein the reflective luminous layer includes a resin and a phosphor having a higher thermal conductivity than the resin.

In some implementations, the reflective luminous layer may further include titanium dioxide (TiO₂), and the thermal conductivity of the phosphor may be higher than a thermal conductivity of the titanium dioxide.

In some implementations, a percentage of the phosphor in the reflective luminous layer may be 3 to 10%.

In some implementations, the phosphor layer may include a yellow phosphor layer. A part of blue light incident on the phosphor layer may be incident on the yellow phosphor layer for outputting the yellow light, and another part of the blue light transmitted through the phosphor layer may be incident on a yellow phosphor in the reflective luminous layer for outputting the yellow light.

In some implementations, the phosphor layer may include a yellow phosphor layer, which is disposed in a first area on the reflective luminous layer, and a green phosphor layer, which is disposed in a second area on the reflective luminous layer.

In some implementations, a yellow phosphor may be disposed in the reflective luminous layer corresponding to the first area, and a green phosphor may be disposed in the reflective luminous layer corresponding to the second area.

In some implementations, a size of the first area may be greater than a size of the second area.

In some implementations, the phosphor wheel may further include a red phosphor layer disposed in a third area on the reflective luminous layer.

In some implementations, a red phosphor may be disposed in the reflective luminous layer corresponding to the third area.

In some implementations, the phosphor wheel may further include an anti-reflective layer disposed on the phosphor layer.

In some implementations, the phosphor wheel may further include a blade spaced downward from the substrate and rotating about a rotation axis.

According to another aspect, a phosphor wheel includes a substrate, a reflective luminous layer disposed on the substrate, and a phosphor layer disposed on the reflective luminous layer, wherein the reflective luminous layer includes a resin, a phosphor, and titanium dioxide (TiO₂).

In some implementations, the phosphor in the reflective luminous layer may have a higher thermal conductivity than the resin.

In some implementations, the phosphor layer may include a yellow phosphor layer. A part of blue light incident on the phosphor layer may be incident on the yellow phosphor layer for outputting the yellow light, and another part of the blue light transmitted through the phosphor layer may be incident on a yellow phosphor in the reflective luminous layer for outputting the yellow light.

According to another aspect, an image projection device includes a light source configured to output blue light, and a phosphor wheel configured to output light of a plurality of colors based on the incident blue light during rotation of the phosphor wheel. The phosphor wheel includes a substrate, a reflective luminous layer disposed on the substrate, and a phosphor layer disposed on the reflective luminous layer. The reflective luminous layer includes a resin and a phosphor having a higher thermal conductivity than the resin.

In some implementations, the image projection device may further include a color filter placed after an output end of the phosphor wheel and configured to sequentially output yellow light, green light, and red light through rotation.

In some implementations, the color filter may be further configured to output blue light.

In some implementations, the color filter may include a yellow area for yellow light output, a green area for green light output, a red area for red light output, and a blue area for blue light output.

In some implementations, a size of the yellow area or the blue area may be less than a size of the red area or the green area.

### Effects of the Disclosure

A phosphor wheel according to an embodiment of the present disclosure includes a substrate, a reflective luminous layer disposed on the substrate, and a phosphor layer disposed on the reflective luminous layer. The reflective luminous layer includes a resin and a phosphor having a higher thermal conductivity than the resin. Accordingly, it is possible to improve light conversion efficiency and thermal conductivity. In addition, it is possible to provide high-efficiency light output and improved color purity.

Meanwhile, the reflective luminous layer further includes titanium dioxide (TiO₂), and the thermal conductivity of the phosphor is preferably higher than a thermal conductivity of the titanium dioxide. Thus, it is possible to improve light conversion efficiency and thermal conductivity.

Meanwhile, a percentage of the phosphor in the reflective luminous layer is preferably 3 to 10%. Accordingly, it is possible to improve light conversion efficiency and thermal conductivity.

Meanwhile, as the phosphor layer includes a yellow phosphor layer, a part of blue light incident on the phosphor layer may be incident on the yellow phosphor layer for outputting the yellow light, and another part of the blue light transmitted through the phosphor layer may be incident on a yellow phosphor in the reflective luminous layer for outputting the yellow light. Thus, it is possible to improve light conversion efficiency and thermal conductivity.

Meanwhile, the phosphor layer may include a yellow phosphor layer, which is disposed in a first area on the reflective luminous layer, and a green phosphor layer, which is disposed in a second area on the reflective luminous layer. This allows the phosphor wheel to output the yellow light and the green light.

Meanwhile, a yellow phosphor may be disposed in the reflective luminous layer corresponding to the first area, and a green phosphor may be disposed in the reflective luminous layer corresponding to the second area. Accordingly, it is possible to improve light conversion efficiency and thermal conductivity.

Meanwhile, a size of the first area is preferably greater than a size of the second area. Thus, it is possible to provide high-efficiency light output and improved color purity.

Meanwhile, the phosphor wheel may further include a red phosphor layer disposed in a third area on the reflective luminous layer. This allows the phosphor wheel to output the red light.

Meanwhile, a red phosphor is disposed in the reflective luminous layer corresponding to the third area. Accordingly, it is possible to improve light conversion efficiency and thermal conductivity.

Meanwhile, the phosphor wheel may further include an anti-reflective layer disposed on the phosphor layer. Thus, it is possible to improve light conversion efficiency and thermal conductivity.

Meanwhile, the phosphor wheel may further include a blade spaced downward from the substrate and rotating about a rotation axis. Accordingly, it is possible to improve heat dissipation performance. Further, it is possible to output light with high luminance.

A phosphor wheel according to another embodiment of the present disclosure includes a substrate, a reflective luminous layer disposed on the substrate and a phosphor layer disposed on the reflective luminous layer. The reflective luminous layer includes a resin, a phosphor, and titanium dioxide (TiO₂). Accordingly, it is possible to improve light conversion efficiency and thermal conductivity. In addition, it is possible to provide high-efficiency light output and improved color purity.

Meanwhile, it is preferable that the phosphor in the reflective luminous layer has a higher thermal conductivity than the resin. Thus, it is possible to improve light conversion efficiency and thermal conductivity.

Meanwhile, as the phosphor layer includes a yellow phosphor layer, a part of blue light incident on the phosphor layer may be incident on the yellow phosphor layer for outputting the yellow light, and another part of the blue light transmitted through the phosphor layer may be incident on a yellow phosphor in the reflective luminous layer for outputting the yellow light. Accordingly, it is possible to improve light conversion efficiency and thermal conductivity.

An image projection device according to an embodiment of the present disclosure includes a light source configured to output blue light and a phosphor wheel configured to output light of a plurality of colors based on the incident blue light during rotation of the phosphor wheel. The phosphor wheel includes a substrate, a reflective luminous layer disposed on the substrate, and a phosphor layer disposed on the reflective luminous layer. The reflective luminous layer includes a resin and a phosphor having a higher thermal conductivity than the resin. Accordingly, it is possible to improve light conversion efficiency and thermal conductivity. In addition, it is possible to provide high-efficiency light output and improved color purity.

Meanwhile, the image projection device may further include a color filter placed after an output end of the phosphor wheel and configured to sequentially output yellow light, green light, and red light through rotation. Thus, it is possible to improve light conversion efficiency and thermal conductivity. Meanwhile, the color filter may be further configured to output blue light.

Meanwhile, the color filter may include a yellow area for yellow light output, a green area for green light output, a red area for red light output, and a blue area for blue light output. Accordingly, it is possible to improve light conversion efficiency and thermal conductivity.

Meanwhile, it is preferably that a size of the yellow area or the blue area is less than a size of the red area or the green area. Thus, it is possible to provide high-efficiency light output and improved color purity.

### BRIEF DESCRIPTION OF THE DRAWINGS

FIG. 1 illustrates an outer appearance of an image projection device according to an embodiment of the present disclosure.

FIG. 2 illustrates an example of an internal block diagram of the image projection device of FIG. 1.

FIG. 3 illustrates an example of an internal block diagram of a signal processing device of FIG. 2.

FIG. 4 illustrates a structure of an image projection device according to an embodiment of the present disclosure.

FIG. 5A illustrates a phosphor wheel of FIG. 4.

FIGS. 5B to 5E are views for explaining the phosphor wheel of FIG. 5A.

FIG. 6 illustrates a structure of an image projection device according to another embodiment of the present disclosure.

FIG. 7A illustrates a phosphor wheel of FIG. 6.

FIGS. 7B and 7C are views for explaining the phosphor wheel of FIG. 7A.

FIG. 8 illustrates a color filter of FIG. 2.

FIG. 9 illustrates a structure of an image projection device according to yet another embodiment of the present disclosure.

FIG. 10A illustrates a phosphor wheel of FIG. 9.

FIG. 10B is a side view of the phosphor wheel of FIG. 10A.

FIGS. 11A to 11D are views for explaining the phosphor wheel of FIG. 7A.

FIGS. 12A and 12B are flowcharts illustrating a method of manufacturing a phosphor wheel according to an embodiment of the present disclosure.

### DETAILED DESCRIPTION OF THE PREFERRED EMBODIMENTS

Description will now be given in detail according to exemplary embodiments disclosed herein, with reference to the accompanying drawings.

The terms “module” and “unit” used to signify components or elements are used herein only for ease of description of the present disclosure, which do not have any distinguishable meanings or functions. Therefore, the terms “module” and “unit” may be used interchangeably.

An optical device described herein is a device capable of outputting visible light. The optical device may be employed in an image projection device. Alternatively, it may be employed in a lighting device.

An image projection device or apparatus described herein is a device capable of projecting an image to the outside. For example, it may be a projector.

Meanwhile, the image projection device described herein may be mounted in another device or apparatus as a component. For example, the image projection device may be mounted in a mobile terminal. Alternatively, the image projection device may be included in a home appliance such as an air conditioner, a refrigerator, a cooking apparatus, a robot cleaner, or the like. Alternatively, the image projection device may be mounted inside a vehicle such as a car.

Such an image projection device will be described in detail below.

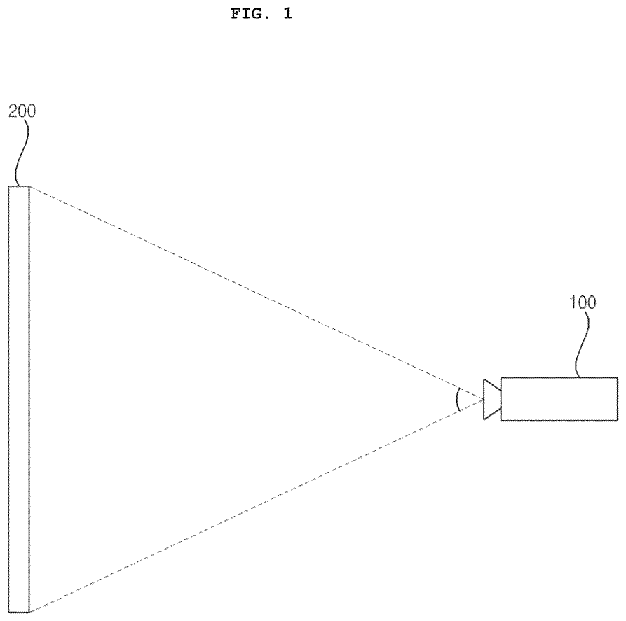

FIG. 1 illustrates an outer appearance of an image projection device according to an embodiment of the present disclosure.

Referring to FIG. 1, an image projection device 100 may project a projection image on a screen 200.

Although it is illustrated that the screen 200 has a flat surface, the screen 200 may have a curved surface.

A user can watch the image projected on the screen 200.

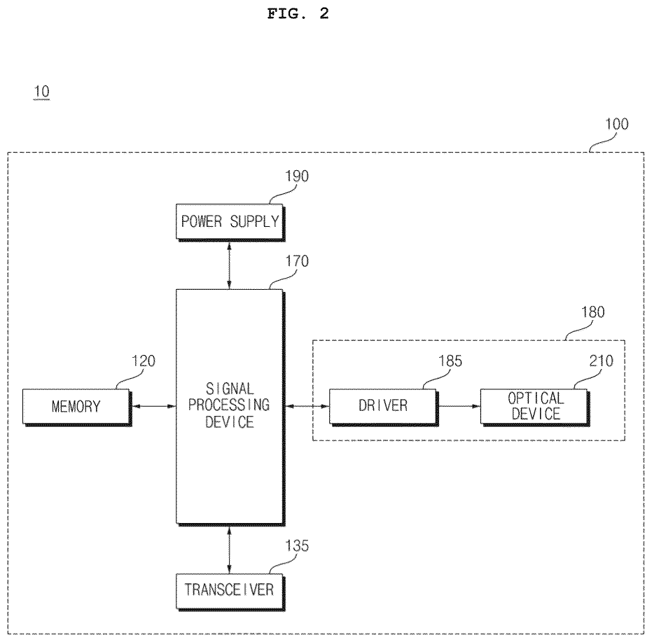

FIG. 2 illustrates an example of an internal block diagram of the image projection device of FIG. 1.

Referring to FIG. 2, the image projection device 100 may include a memory 120, a signal processing device 170, a transceiver 135, an image output device 180, and a power supply 190.

The image output device 180 may include a driver 185 and an optical device 210.

The driver 185 may cause the optical device 210 to be driven. Specifically, the driver 185 may cause a light source in the optical device 210 to be driven.

The optical device 210 may include optical components, such as a light source, a lens, and the like, for light output, namely, for visible light output.

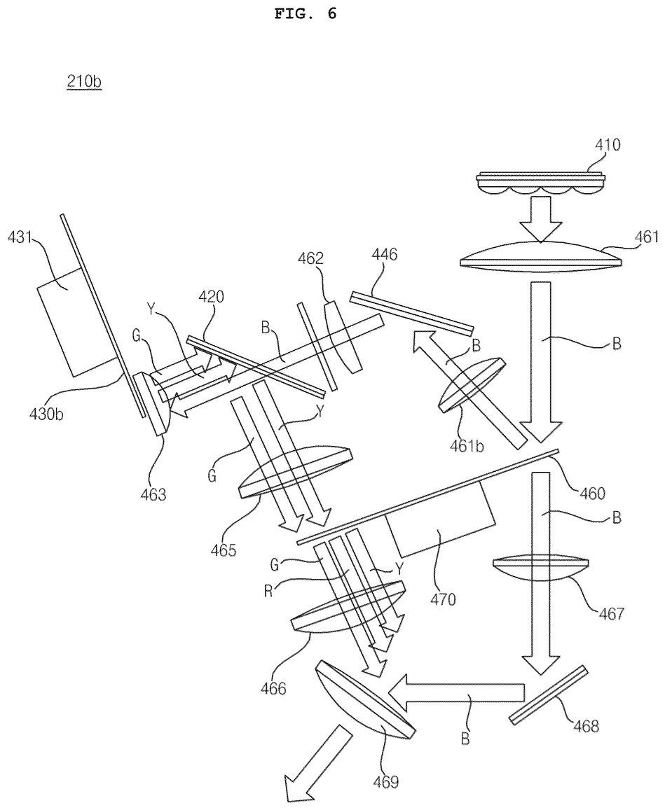

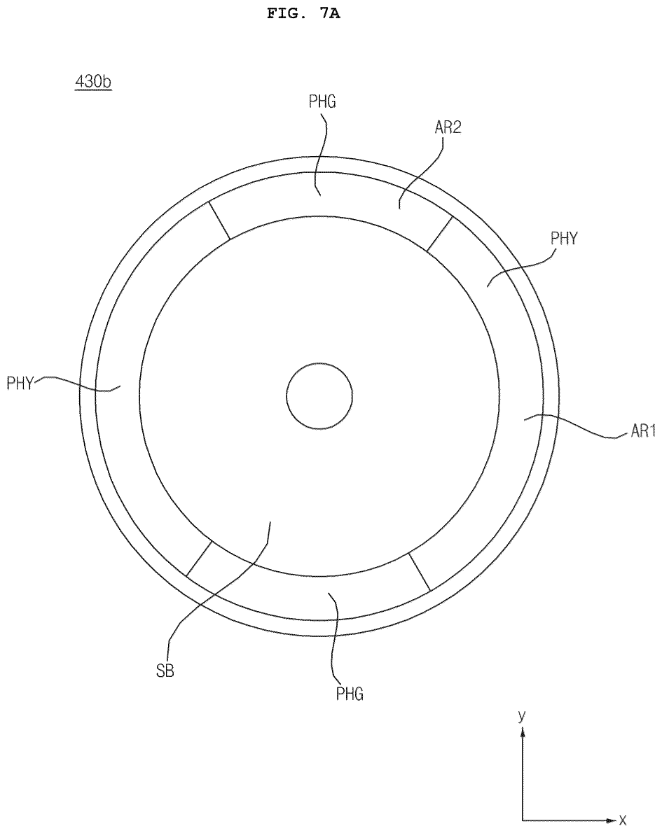

Particularly, in some embodiments, an optical device with improved light conversion efficiency and thermal conductivity is provided. This will be described later with reference to FIG. 6 and subsequent figures.

The memory 120 may store a program for processing or control of the signal processing device 170, and may temporarily store input or output data (e.g., still images, moving images, etc.).

The transceiver 135 serves as an interface with all external devices connected to the image projection device 100 in a wired or wireless manner or with a network. The transceiver 135 may receive data or power from an external device and transmit the received data or power to each of the components in the image projection device 100. In addition, the transceiver 135 may transmit data from the image projection device 100 to an external device.

In particular, the transceiver 135 may receive a wireless signal from a nearby mobile terminal (not shown). The wireless signal may include a voice call signal, a video communication call signal, or various types of data such as text data and image data.

To this end, the transceiver 135 may include a short-range transceiver (not shown). Bluetooth, radio frequency identification (RFID), infrared data association (IrDA), ultra-wideband (UWB), ZigBee, near field communication (NFC), or the like may be used as short-range communication technology.

The signal processing device 170 may control the overall operation of the image projection device 100. In detail, the signal processing device 170 may control the operation of the respective portions in the image projection device 100.

The signal processing device 170 may control such that a video image stored in the memory 120 or a video image received from an external device through the transceiver 135 is output to the outside as a projection image.

To this end, the signal processing device 170 may control the driver 185 to control the optical device 210 configured to output visible light, including red (R), green (G), and blue (B) light. In detail, R, G, and B signals corresponding to a video image to be displayed may be output to the driver 185.

The power supply 190 may receive external power or internal power under the control of the signal processing device 170 so as to supply power required for the operation of the respective components.

The power supply 190 may supply power throughout the image projection device 100. Specifically, the power supply 190 may supply power to the signal processing device 170, which can be configured in the form of a system on chip (SOC), the image output device 180 for image display, and an audio output device (not shown) for audio output.

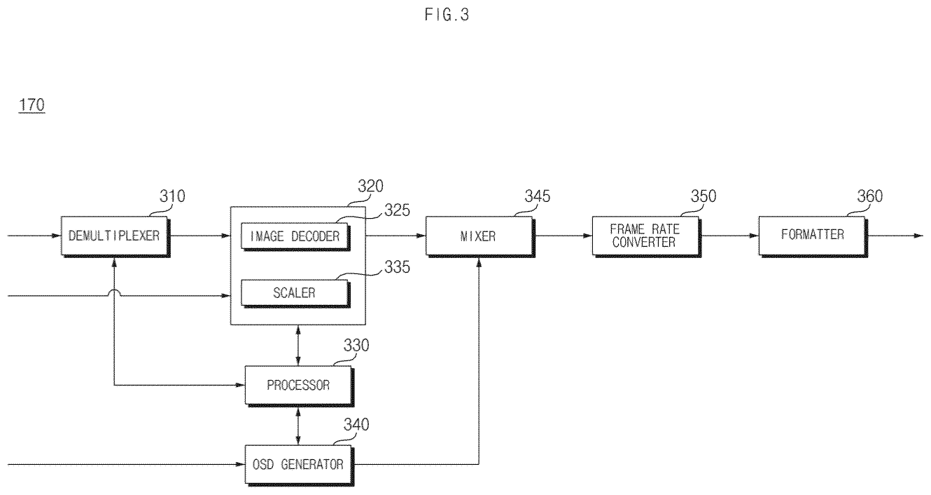

FIG. 3 illustrates an example of an internal block diagram of a signal processing device of FIG. 2.

Referring to FIG. 3, the signal processing device 170 according to an embodiment of the present disclosure may include a demultiplexer 310, an image processor 320, a processor 330, an OSD generator 340, a mixer 345, a frame rate converter 350, and a formatter 360. The signal processing device 170 may further include an audio processor (not shown) and a data processor (not shown).

The demultiplexer 310 may demultiplex an input stream.

The image processor 320 may process a demultiplexed image signal. To this end, the image processor 320 may include an image decoder 325 and a scaler 335.

The image decoder 325 may decode the demultiplexed image signal, and the scaler 335 may scale the resolution of the decoded image signal to output the image signal via the image output device 180. The image decoder 325 may include decoders for various standards.

The processor 330 may control the overall operation of the image projection device 100 or the signal processing device 170. In addition, the processor 330 may control the operation of the demultiplexer 310, the image processor 320, and the OSD generator 340 of the signal processing device 170.

The OSD generator 340 may generate an OSD signal autonomously or according to a user input.

The mixer 345 may mix the OSD signal generated by the OSD generator 340 with the decoded image signal processed by the image processor 320. The mixed image signal may be provided to the frame rate converter 350.

The frame rate converter (FRC) 350 may convert the frame rate of an input image. Alternatively, the frame rate converter 350 may directly output an input image without conversion of the frame rate of the input image.

The formatter 360 may receive the signal mixed by the mixer 345, i.e., the OSD signal and the decoded image signal, and may perform signal conversion to input the signal to the image output device 180. For example, the formatter 360 may output a low voltage differential signal (LVDS).

Meanwhile, the block diagram of the signal processing device 170 shown in FIG. 3 is merely one example of the present disclosure. Respective components of the block diagram may be combined, added, or omitted depending on the specification of a signal processing device 170 that is actually implemented.

In particular, the frame rate converter 350 and the formatter 360 may be separately provided, instead of being included in the signal processing device 170. Alternatively, the frame rate converter 350 and the formatter 360 may be provided as a single module separately from the signal processing device 170.

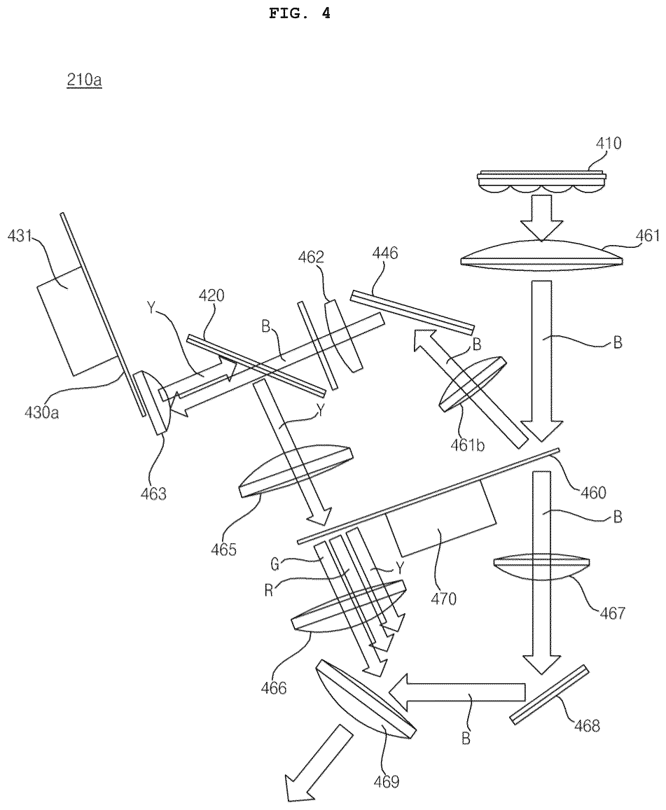

FIG. 4 illustrates a structure of an image projection device according to an embodiment of the present disclosure.

Referring to FIG. 4, an optical device 210a according to an embodiment of the present disclosure may include a light source 410 configured to output blue light B, and a phosphor wheel 430a configured to output yellow light Y based on the incident blue light B during rotation thereof.

Meanwhile, the light source 410 outputting blue light B may be a laser diode or the like. For example, the laser diode 410 may output blue laser light B.

The blue light B output by the light source 410 may be collected or condensed bypassing through a collimator lens 461, and then may be incident on a color filter 460.

The optical device 210a of this embodiment may further include the color filter 460 placed after an output end of the phosphor wheel 430a and configured to sequentially output yellow light Y, green light G, and red light R through rotation.

For example, the color filter 460 may include a yellow area ARa for yellow light Y output, a green area ARb for green light G output, a red area ARc for red light R output, and a blue area ARd for blue light B output.

When the blue light B from the light source 410 is incident on the yellow area ARa, the green area ARb, or the red area ARc for red light R output, the color filter 460 reflects the blue light B.

The blue light B reflected by the color filter 460 passes through a collimator lens 461b and is then incident on a first reflective mirror 446.

The first reflective mirror 446 reflects the incident blue light B, and the blue light B reflected by the first reflective mirror 446 passes through a collimator lens 462 and is then incident on a light splitter 420.

The light splitter 420 allows the incident blue light B to pass therethrough, while reflecting other light such as yellow light Y, green light G, or red light R.

The blue light B transmitted through the light splitter 420 passes through a collimator lens 463 and is then incident on the phosphor wheel 430a.

The phosphor wheel 430a outputs yellow light Y based on the incident blue light B during rotation thereof.

Specifically, the phosphor wheel 430a includes a yellow phosphor layer PHY for yellow light Y output.

When the blue light B is incident on the yellow phosphor layer PHY in the phosphor wheel 430a, the phosphor wheel 430a reflects and outputs yellow light Y.

The yellow light Y output by the phosphor wheel 430a is incident on the light splitter 420. Then, the light splitter 420 reflects the yellow light Y.

The yellow light Y reflected by the light splitter 420 is incident on the color filter 460.

When the yellow light Y reflected by the light splitter 420 is incident on the yellow area ARa of the color filter 460, the color filter 460 transmits and outputs the yellow light Y.

When the yellow light Y reflected by the light splitter 420 is incident on the green area ARb of the color filter 460, the color filter 460 transmits and outputs green light G.

When the yellow light Y reflected by the light splitter 420 is incident on the red area ARc of the color filter 460, the color filter 460 transmits and outputs red light R.

The yellow light Y, green light G, and red light R from the color filter 460 are output in a first direction by a collimator lens 469.

Meanwhile, the blue light B transmitted through the phosphor wheel 430a passes through a second reflective mirror 468 and is then output in the first direction by the collimator lens 463.

Accordingly, the yellow light Y, the green light G, the red light R, and the blue light B are sequentially output in the first direction.

Meanwhile, the phosphor wheel 430a according to an embodiment of the present disclosure includes a substrate SB, a reflective light-emitting (or emission) layer AE disposed on the substrate SB, and a phosphor layer PH disposed on the reflective luminous layer AE. The reflective luminous layer AE includes a resin TR and a phosphor TOT having a higher thermal conductivity than the resin TR. Accordingly, it is possible to improve light conversion efficiency and thermal conductivity. In addition, it is possible to provide high-efficiency light output and improved color purity.

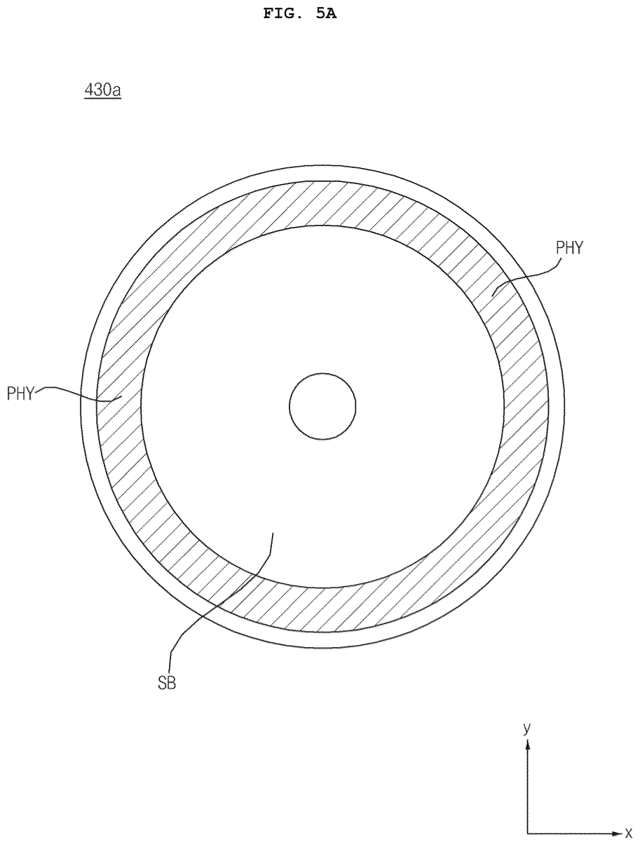

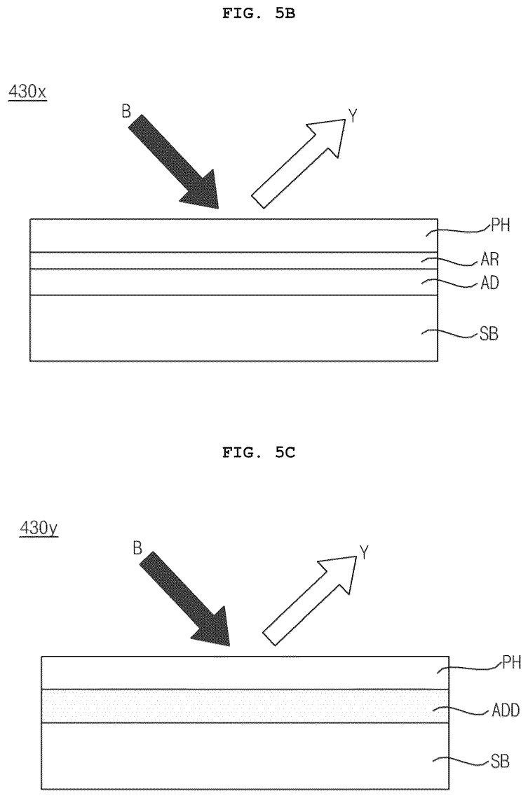

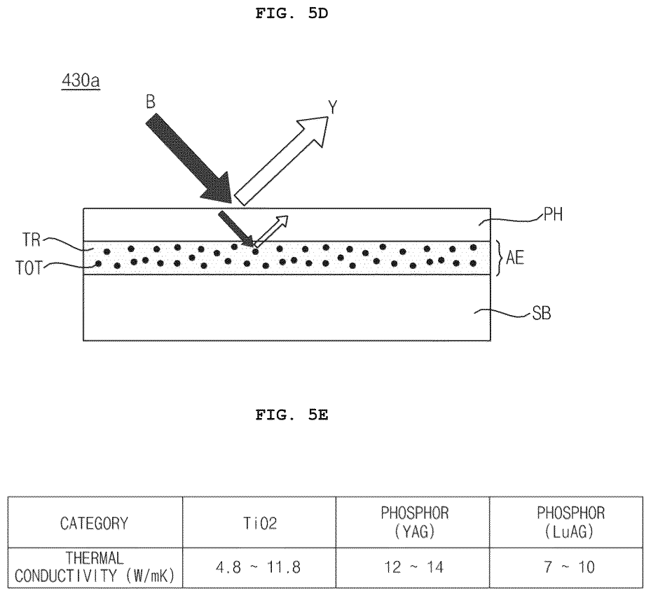

Meanwhile, the reflective luminous layer AE further includes titanium dioxide (TiO₂), and the thermal conductivity of the phosphor TOT is preferably higher than that of the titanium dioxide. Thus, it is possible to improve light conversion efficiency and thermal conductivity. This will be described in more detail with reference to FIG. 5A and subsequent figures.

FIG. 5A illustrates a phosphor wheel of FIG. 4.

Referring to FIG. 5A, the phosphor wheel 430a according to an embodiment of the present disclosure includes a substrate SB and a yellow phosphor layer PHY for yellow light Y output, the yellow phosphor layer PHY being disposed on the substrate SB.

The substrate SB may be, for example, an aluminum (Al) substrate.

Meanwhile, the phosphor wheel 430a further includes a reflective luminous layer AE disposed between the substrate SB and the yellow phosphor layer PHY. The reflective luminous layer AE allows high-efficiency light output and improved color purity to be achieved when yellow light is output from the yellow phosphor layer PHY.

The reflective luminous layer AE includes a resin TR and a phosphor TOT having a higher thermal conductivity than the resin TR. Accordingly, it is possible to improve light conversion efficiency and thermal conductivity. In addition, it is possible to provide high-efficiency light output and improved color purity.

Meanwhile, the reflective luminous layer AE further includes titanium dioxide (TiO₂), and the thermal conductivity of the phosphor TOT is preferably higher than that of the titanium dioxide. Accordingly, it is possible to improve light conversion efficiency and thermal conductivity.

Meanwhile, the percentage of the phosphor TOT in the reflective luminous layer AE is preferably 3 to 10%. Accordingly, it is possible to improve light conversion efficiency and thermal conductivity.

Meanwhile, in another embodiment, the phosphor wheel 430a includes a substrate SB and a reflective luminous layer AE disposed on the substrate SB. The reflective luminous layer AE includes a resin TR, a phosphor, and titanium dioxide (TiO₂). Accordingly, it is possible to improve light conversion efficiency and thermal conductivity. In addition, it is possible to provide high-efficiency light output and improved color purity.

FIGS. 5B to 5E are views for explaining the phosphor wheel of FIG. 5A.

FIG. 5B illustrates an example of a phosphor wheel 430x related to the present disclosure.

Referring to FIG. 5B, the phosphor wheel 430x related to the present disclosure includes, between a substrate SB and a yellow phosphor layer PH, an adhesive layer AD formed of a transparent resin and a reflective layer AR formed of a metal (or metallic) thin film.

In this structure, where a reflective layer and an adhesive layer are separately formed, blue light B is incident and is converted to yellow light by the yellow phosphor layer PH to output the yellow light. However, due to an increase in heat, a reliability issue may occur, which leads to a decrease in light conversion efficiency.

FIG. 5C illustrates another example of a phosphor wheel 430y related to the present disclosure.

Referring to FIG. 5C, the phosphor wheel 430x related to the present disclosure includes, between a substrate SB and a yellow phosphor layer PH, a reflective adhesive layer ADD made of a transparent resin and a TiO₂ powder.

In this structure, where a reflective layer and an adhesive layer are integrally formed, blue light B is incident and is converted to yellow light by the yellow phosphor layer PH to output the yellow light. However, due to an increase in heat, a reliability issue may occur, which leads to a decrease in light conversion efficiency.

Therefore, in the present disclosure, in order to address the problem in FIGS. 5B and 5C, a reflective luminous layer AE including a resin TR and a phosphor TOT having a higher thermal conductivity than the resin TR is disposed under a yellow phosphor layer PH. This will be described below with reference to FIG. 5D.

FIG. 5D is a side view of the phosphor wheel 430a of FIG. 5B.

Referring to FIG. 5D, the phosphor wheel 430a according to an embodiment of the present disclosure includes a substrate SB, a reflective luminous layer AE disposed on the substrate SB, and a phosphor layer PH disposed on the reflective luminous layer AE. The reflective luminous layer AE includes a resin TR and a phosphor TOT having a higher thermal conductivity than the resin TR. Accordingly, it is possible to improve light conversion efficiency and thermal conductivity. In addition, it is possible to provide high-efficiency light output and improved color purity.

In particular, the reflective luminous layer AE includes the transparent resin TR and the phosphor TOT having a higher thermal conductivity than the transparent resin TR.

Meanwhile, as illustrated in the figure, the phosphor layer PH may include a yellow phosphor layer PHY for yellow light Y output, so that a part of blue light B incident on the phosphor layer PH may be incident on the yellow phosphor layer PHY to output yellow light Y, and another part of the blue light B transmitted through the phosphor layer PH may be incident on a yellow phosphor in the reflective luminous layer AE to output yellow light Y. Accordingly, it is possible to improve light conversion efficiency and thermal conductivity. In addition, even when the phosphor layer PH is thick, it does not cause an increase in heat, thereby improving light conversion efficiency.

Meanwhile, the percentage of the phosphor TOT in the reflective luminous layer AE is preferably 3 to 10%. Thus, it is possible to improve light conversion efficiency and thermal conductivity.

More preferably, the percentage of the phosphor TOT in the reflective luminous layer AE is 3 to 5%. Thus, it is possible to improve light conversion efficiency and thermal conductivity.

Meanwhile, the reflective luminous layer AE further includes titanium dioxide (TiO₂), and the thermal conductivity of the phosphor TOT is preferably higher than that of the titanium dioxide.

This will be described below with reference to FIG. 5E.

FIG. 5E is a table showing an example of the thermal conductivity of TiO₂, a yellow phosphor, and a green phosphor.

Meanwhile, a yellow phosphor in the reflective luminous layer AE may include YAG (Yttrium Aluminium Garnet).

Meanwhile, as shown in FIG. 5E, the yellow phosphor in the reflective luminous layer AE has a thermal conductivity of 12 to 14, which is preferably higher than that of titanium dioxide (TiO₂), which is 4.8 to 11.8. Accordingly, it is possible to improve light conversion efficiency and thermal conductivity. In addition, even when the phosphor layer PH is thick, it does not cause an increase in heat, thereby improving light conversion efficiency.

FIG. 6 illustrates a structure of an image projection device according to another embodiment of the present disclosure.

Referring to FIG. 6, an optical device 210b according to another embodiment of the present disclosure includes a light source 410 configured to output blue light B, and a phosphor wheel 430b configured to output light of a plurality of colors based on the incident blue light B during rotation thereof.

Meanwhile, the light source 410 outputting blue light B may be a laser diode or the like. For example, the laser diode 410 may output blue laser light B.

The blue light B output by the light source 410 may be collected or condensed bypassing through a collimator lens 461, and then may be incident on a color filter 460.

The optical device 210b of this embodiment may further include the color filter 460 placed after an output end of the phosphor wheel 430b and configured to sequentially output yellow light Y, green light G, and red light R through rotation.

For example, the color filter 460 may include a yellow area ARa for yellow light Y output, a green area ARb for green light G output, a red area ARc for red light R output, and a blue area ARd for blue light B output.

When the blue light B from the light source 410 is incident on the yellow area ARa, the green area ARb, or the red area Arc for red light R output, the color filter 460 reflects the blue light B.

The blue light B reflected by the color filter 460 passes through a collimator lens 461b and is then incident on a first reflective mirror 446.

The first reflective mirror 446 reflects the incident blue light B, and the blue light B reflected by the first reflective mirror 446 passes through a collimator lens 462 and is then incident on a light splitter 420.

The light splitter 420 allows the incident blue light B to pass therethrough, while reflecting other light such as yellow light Y or green light G.

The blue light B transmitted through the light splitter 420 passes through a collimator lens 463 and is then incident on the phosphor wheel 430b.

The phosphor wheel 430b outputs light of a plurality of colors based on the incident blue light B during rotation thereof.

Specifically, the phosphor wheel 430b includes a yellow phosphor layer PHY for yellow light Y output and a green phosphor layer PHG for green light G output.

When the blue light B is incident on the yellow phosphor layer PHY in the phosphor wheel 430b, the phosphor wheel 430b reflects and outputs yellow light Y.

When the blue light B is incident on the green phosphor layer PHG in the phosphor wheel 430b, the phosphor wheel 430b reflects and outputs green light G.

The yellow light Y and green light G sequentially output by the phosphor wheel 430b are incident on the light splitter 420. Then, the light splitter 420 reflects the yellow light Y and the green light G.

The yellow light Y and green light G reflected by the light splitter 420 are incident on the color filter 460.

When the yellow light Y reflected by the light splitter 420 is incident on the yellow area ARa of the color filter 460, the color filter 460 transmits and outputs the yellow light Y.

When the green light G reflected by the light splitter 420 is incident on the green area ARb of the color filter 460, the color filter 460 transmits and outputs the green light G.

When the yellow light Y or the green light G reflected by the light splitter 420 is incident on the red area ARc of the color filter 460, the color filter 460 transmits and outputs red light R.

The yellow light Y, green light G, and red light R from the color filter 460 are output in a first direction by a collimator lens 469.

Meanwhile, the blue light B transmitted through the phosphor wheel 430b passes through a second reflective mirror 468 and is then output in the first direction by the collimator lens 463.

Accordingly, the yellow light Y, the green light G, the red light R, and the blue light B are sequentially output in the first direction.

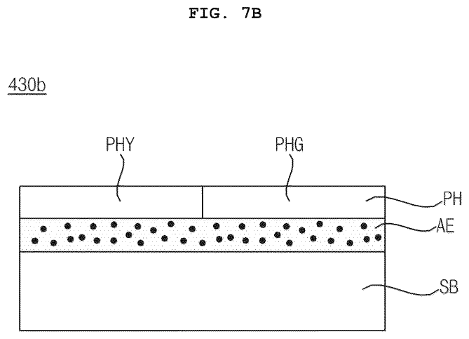

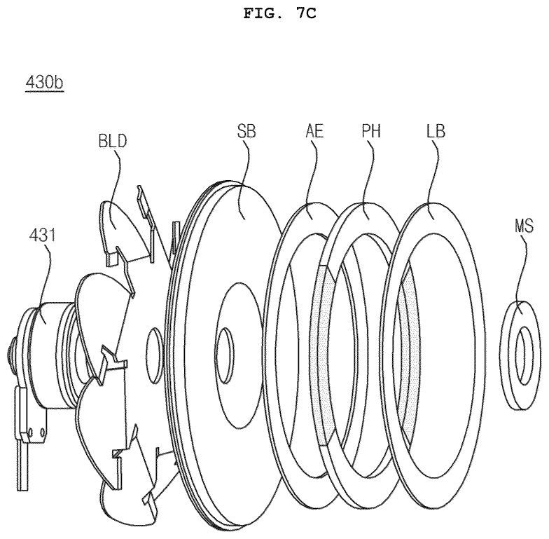

FIG. 7A illustrates a phosphor wheel of FIG. 6.

Referring to FIG. 7A, the phosphor wheel 430b according to another embodiment of the present disclosure includes a substrate SB, a reflective luminous layer AE disposed on the substrate SB, and a phosphor layer PH disposed on the reflective luminous layer AE. The reflective luminous layer AE includes a resin TR and a phosphor TOT having a higher thermal conductivity than the resin TR. Accordingly, it is possible to improve light conversion efficiency and thermal conductivity. In addition, it is possible to provide high-efficiency light output and improved color purity.

The phosphor layer PH may include a yellow phosphor layer PHY for yellow light Y output, which is disposed in a first area AR1 on the reflective luminous layer AE, and a green phosphor layer PHG for green light G output, which is disposed in a second area AR2 on the reflective luminous layer AE.

FIGS. 7B and 7C are views for explaining the phosphor wheel of FIG. 7A.

FIG. 7B is a side view of FIG. 7A.

Referring to FIG. 7B, the substrate SB in the phosphor wheel 430b according to another embodiment of the present disclosure may be, for example, an aluminum (Al) substrate.

The reflective luminous layer AE in the phosphor wheel 430b according to another embodiment of the present disclosure includes a resin TR and a phosphor TOT having a higher thermal conductivity than the resin TR. Accordingly, it is possible to improve light conversion efficiency and thermal conductivity. In addition, it is possible to provide high-efficiency light output and improved color purity.

Meanwhile, the reflective luminous layer AE further includes titanium dioxide (TiO₂), and the thermal conductivity of the phosphor TOT is preferably higher than that of the titanium dioxide. Accordingly, it is possible to improve light conversion efficiency and thermal conductivity.

Meanwhile, the reflective luminous layer AE further includes titanium dioxide (TiO₂), and the thermal conductivity of the phosphor TOT is preferably higher than that of the titanium dioxide. Accordingly, it is possible to improve light conversion efficiency and thermal conductivity.

Meanwhile, the percentage of the phosphor TOT in the reflective luminous layer AE is preferably 3 to 10%. Accordingly, it is possible to improve light conversion efficiency and thermal conductivity.

The phosphor layer PH in the phosphor wheel 430b according to another embodiment of the present disclosure may include a yellow phosphor layer PHY for yellow light Y output, which is disposed in a first area AR1 on the reflective luminous layer AE, and a green phosphor layer PHG for green light G output, which is disposed in a second area AR2 on the reflective luminous layer AE. This allows the phosphor wheel 430a to output the yellow light Y and the green light G.

Meanwhile, a yellow phosphor may be disposed in the reflective luminous layer AE corresponding to the first area AR1, and a green phosphor may be disposed in the reflective luminous layer AE corresponding to the second area AR2. Accordingly, it is possible to improve light conversion efficiency and thermal conductivity.

Meanwhile, it is preferable that a size of the first area AR1 is greater than a size of the second area AR2. Accordingly, it is possible to provide high-efficiency light output and improved color purity.

Meanwhile, a yellow phosphor may be disposed in the reflective luminous layer AE corresponding to the first area AR1, and a green phosphor may be disposed in the reflective luminous layer AE corresponding to the second area AR2.

Accordingly, it is possible to improve light conversion efficiency and thermal conductivity.

FIG. 7C is an exploded view of the phosphor wheel 430b of FIG. 6.

Referring to FIG. 7C, from the −z axis direction to the z-axis direction, a motor 431, a blade BLD, a substrate SB, a reflective luminous layer LE, a phosphor layer PH, an anti-reflective layer LB, and a housing MS for coupling may be arranged.

As the motor 431, the blade BLD, the substrate SB, the reflective luminous layer LE, the phosphor layer PH, the anti-reflective layer LB, and the housing MS for coupling are coupled together, the phosphor wheel 430b of FIG. 7C is achieved.

Meanwhile, the phosphor wheel 430b may further include the anti-reflective layer LB disposed on the phosphor layer PH. Accordingly, it is possible to improve light conversion efficiency and thermal conductivity.

Meanwhile, the phosphor wheel 430a may further include the blade BLD spaced downward from the substrate SB and rotating about a rotation axis. Accordingly, it is possible to improve heat dissipation performance. Furthermore, it is possible to output light with high luminance.

Meanwhile, as described above, the reflective luminous layer LE includes the resin TR and the phosphor TOT having a higher thermal conductivity than the resin TR. Accordingly, it is possible to improve light conversion efficiency and thermal conductivity. In addition, it is possible to provide high-efficiency light output and improved color purity.

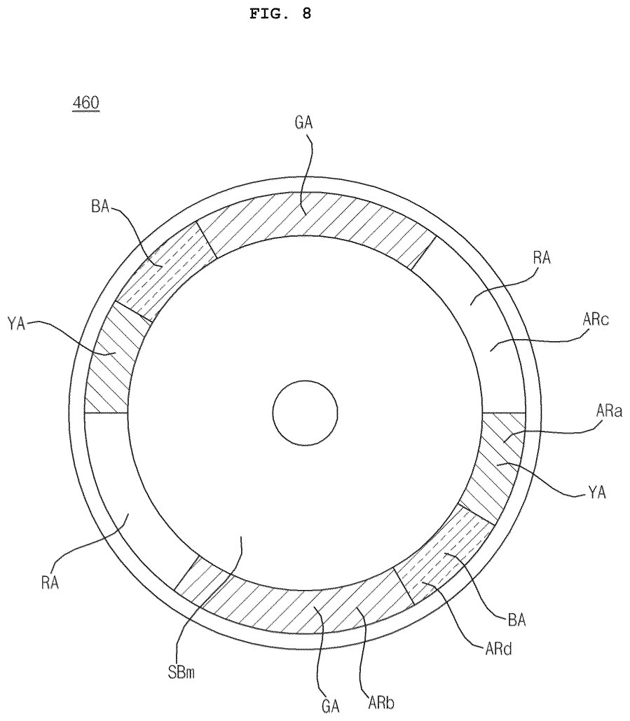

FIG. 8 illustrates a color filter of FIG. 2.

Referring to FIG. 8, the color filter 460 according to an embodiment of the present disclosure is placed after an output end of the phosphor wheel 430a, and sequentially outputs yellow light Y, green light G, and red light R through rotation.

Meanwhile, the color filter 460 according to an embodiment of the present disclosure may be placed after an output end of the phosphor wheel 430a, and may sequentially output yellow light Y, green light G, red light R, and blue light B through rotation.

To this end, the color filter 460 may include a yellow area ARa for yellow light Y output, a green area ARb for green light G output, a red area ARc for red light R output, and a blue area ARd for blue light B output.

Meanwhile, as shown in FIG. 8, the yellow area ARa or the blue area ARd may be smaller in size than the red area ARc or the green area Arb. Accordingly, it is possible to provide high-efficiency light output and improved color purity.

In particular, FIG. 8 illustrates that the size of the blue area ARd is the smallest, and the size increases in the order of the yellow area ARa, the red area ARc, and the green area ARb. Thus, it is possible to provide high-efficiency light output and improved color purity.

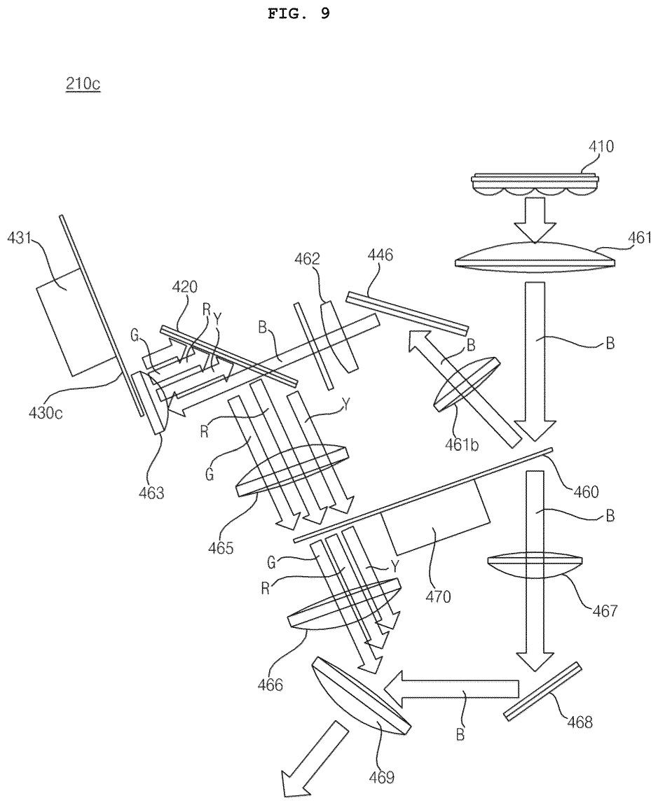

FIG. 9 illustrates a structure of an image projection device according to yet another embodiment of the present disclosure.

Referring to FIG. 9, an optical device 210c according to an embodiment of the present disclosure includes a light source 410 configured to output blue light B, and a phosphor wheel 430c configured to output light of a plurality of colors based on the incident blue light B during rotation thereof.

Meanwhile, the light source 410 outputting blue light B may be a laser diode or the like. For example, the laser diode 410 may output blue laser light B.

The blue light B output by the light source 410 may be collected or condensed bypassing through a collimator lens 461, and then may be incident on the color filter 460.

The optical device 210c of this embodiment may further include a color filter 460 placed after an output end of the phosphor wheel 430c and configured to sequentially output yellow light Y, green light G, and red light R through rotation.

For example, the color filter 460 may include a yellow area ARa for yellow light Y output, a green area ARb for green light G output, a red area ARc for red light R output, and a blue area ARd for blue light B output.

When the blue light B from the light source 410 is incident on the yellow area ARa, the green area ARb, or the red area ARc for red light R output, the color filter 460 reflects the blue light B.

The blue light B reflected by the color filter 460 passes through a collimator lens 461b and is then incident on a first reflective mirror 446.

The first reflective mirror 446 reflects the incident blue light B, and the blue light B reflected by the first reflective mirror 446 passes through a collimator lens 462 and is then incident on a light splitter 420.

The light splitter 420 allows the incident blue light B to pass therethrough, while reflecting other light such as yellow light Y, green light G, or red light R.

The blue light B transmitted through the light splitter 420 passes through a collimator lens 463 and is then incident on the phosphor wheel 430c.

The phosphor wheel 430c outputs light of a plurality of colors based on the incident blue light B during rotation thereof.

Specifically, the phosphor wheel 430c includes a yellow phosphor layer PHY for yellow light Y output, a green phosphor layer PHG for green light G output, and a red phosphor layer PHR for red light R output.

When the blue light B is incident on the yellow phosphor layer PHY in the phosphor wheel 430c, the phosphor wheel 430c reflects and outputs yellow light Y.

When the blue light B is incident on the green phosphor layer PHG in the phosphor wheel 430c, the phosphor wheel 430c reflects and outputs green light G.

When the blue light B is incident on the red phosphor layer PHR in the phosphor wheel 430c, the phosphor wheel 430c reflects and outputs red light R.

The yellow light Y, green light G, and red light R sequentially output by the phosphor wheel 430c are incident on the light splitter 420. Then, the light splitter 420 reflects the yellow light Y, the green light G, and the red light R.

The yellow light Y, green light G, and red light R reflected by the light splitter 420 are incident on the color filter 460.

When the yellow light Y reflected by the light splitter 420 is incident on the yellow area ARa of the color filter 460, the color filter 460 transmits and outputs the yellow light Y.

When the green light G reflected by the light splitter 420 is incident on the green area ARb of the color filter 460, the color filter 460 transmits and outputs the green light G.

When the red light R reflected by the light splitter 420 is incident on the red area ARc of the color filter 460, the color filter 460 transmits and outputs the red light R.

The yellow light Y, green light G, and red light R from the color filter 460 are output in a first direction by a collimator lens 469.

Meanwhile, the blue light B transmitted through the phosphor wheel 430c passes through a second reflective mirror 468 and is then output in the first direction by the collimator lens 463.

Accordingly, the yellow light Y, the green light G, the red light R, and the blue light B are sequentially output in the first direction.

Meanwhile, the phosphor wheel 430c according to an embodiment of the present disclosure includes a substrate SB, a reflective luminous layer AE disposed on the substrate SB, a yellow phosphor layer PHY for yellow light Y output, a green phosphor layer PHG for green light G output, and a red phosphor layer PHR for red light R output. Accordingly, it is possible to improve light conversion efficiency and thermal conductivity. In addition, it is possible to provide high-efficiency light output and improved color purity.

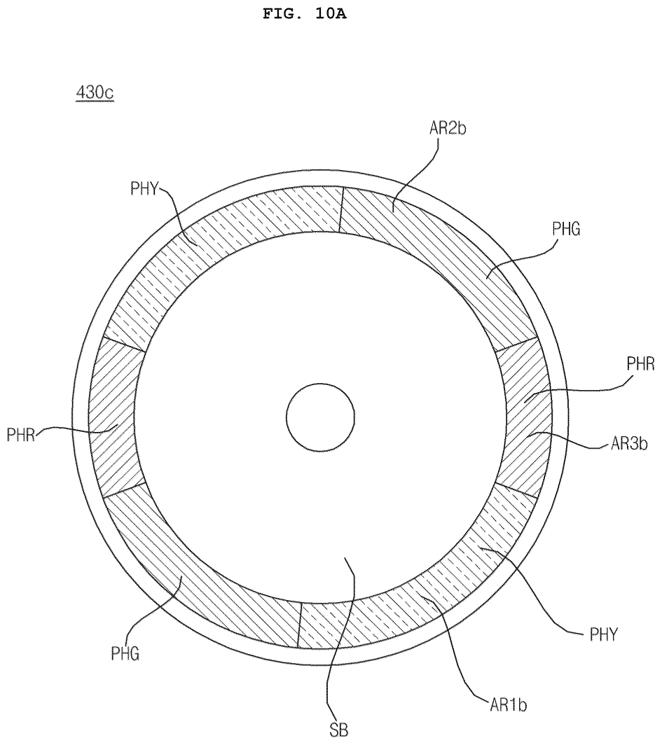

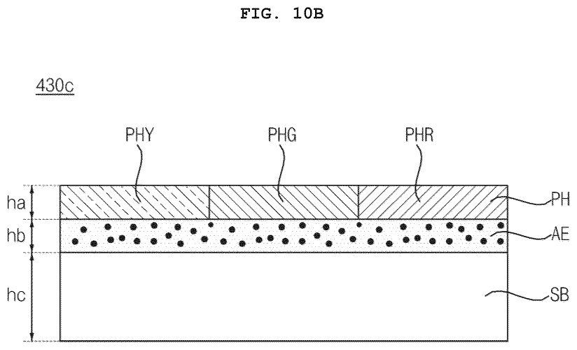

FIG. 10A illustrates a phosphor wheel of FIG. 9.

Referring to FIG. 10A, the phosphor wheel 430c according to yet another embodiment of the present disclosure includes a substrate SB, a reflective luminous layer AE disposed on the substrate SB, and a phosphor layer PH disposed on the reflective luminous layer AE. The reflective luminous layer AE includes a resin TR and a phosphor TOT having a higher thermal conductivity than the resin TR. Accordingly, it is possible to improve light conversion efficiency and thermal conductivity. In addition, it is possible to provide high-efficiency light output and improved color purity.

The phosphor layer PH may include a yellow phosphor layer PHY for yellow light Y output, which is disposed in a first area AR1b on the reflective luminous layer AE, a green phosphor layer PHG for green light G output, which is disposed in a second area AR2b on the reflective luminous layer AE, and a red phosphor layer PHG for red light R output, which is disposed in a third area Ar3b on the reflective luminous layer AE.

FIG. 10B is a side view of the phosphor wheel of FIG. 10A.

Referring to FIG. 10B, the substrate SB in the phosphor wheel 430c according to yet another embodiment of the present disclosure may be, for example, an aluminum (Al) substrate.

The reflective luminous layer AE in the phosphor wheel 430c according to yet another embodiment of the present disclosure includes a resin TR and a phosphor TOT having a higher thermal conductivity than the resin TR. Accordingly, it is possible to improve light conversion efficiency and thermal conductivity. In addition, it is possible to provide high-efficiency light output and improved color purity.

Meanwhile, the reflective luminous layer AE further includes titanium dioxide (TiO₂), and the thermal conductivity of the phosphor TOT is preferably higher than that of the titanium dioxide. Accordingly, it is possible to improve light conversion efficiency and thermal conductivity.

Meanwhile, the reflective luminous layer AE further includes titanium dioxide (TiO₂), and the thermal conductivity of the phosphor TOT is preferably higher than that of the titanium dioxide. Accordingly, it is possible to improve light conversion efficiency and thermal conductivity.

Meanwhile, the percentage of the phosphor TOT in the reflective luminous layer AE is preferably 3 to 10%. Accordingly, it is possible to improve light conversion efficiency and thermal conductivity.

The phosphor layer PH in the phosphor wheel 430c according to yet another embodiment of the present disclosure may include a yellow phosphor layer PHY for yellow light Y output, which is disposed in a first area AR1b on the reflective luminous layer AE, a green phosphor layer PHG for green light G output, which is disposed in a second area AR2b on the reflective luminous layer AE, and a red phosphor layer PHR for red light R output, which is disposed in a third area Ar3b on the reflective luminous layer AE. This allows the phosphor wheel 430a to output the yellow light Y, the green light G, and the red light R.

Meanwhile, a yellow phosphor may be disposed in the reflective luminous layer AE corresponding to the first area AR1b, a green phosphor may be disposed in the reflective luminous layer AE corresponding to the second area AR2b, and a red phosphor may be disposed in the reflective luminous layer AE corresponding to the third area Ar3b. Accordingly, it is possible to improve light conversion efficiency and thermal conductivity.

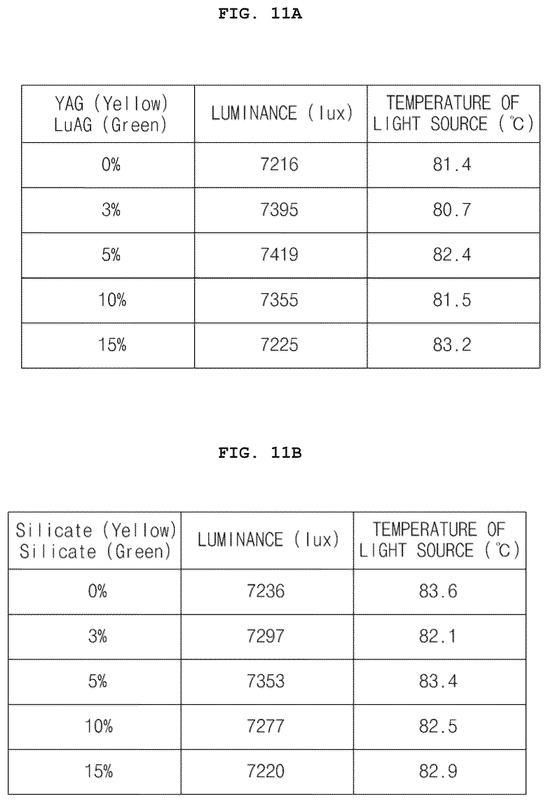

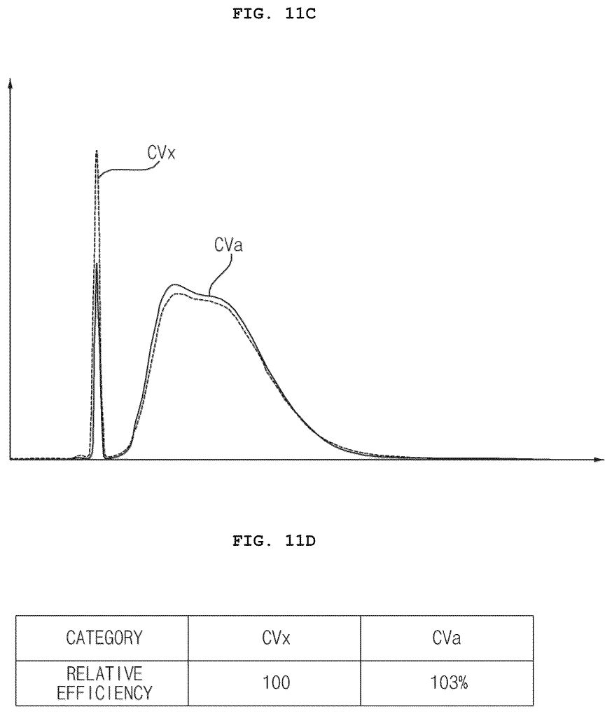

FIGS. 11A to 11D are views for explaining the phosphor wheel of FIG. 7A.

FIG. 1A is a table showing luminance characteristics and temperature characteristics according to the percentage of a yellow phosphor (YAG) and a green phosphor (LuAG) in the reflective luminous layer AE.

Referring to FIG. 11A, as the percentage of the yellow phosphor (YAG) and the green phosphor (LuAG) increases from 0% to 5%, it exhibits an increase in luminance, and as the percentage of the yellow phosphor (YAG) and the green phosphor (LuAG) increases from 5% to 10%, it exhibits a decrease in luminance.

Meanwhile, the temperature is less than approximately 82.5° C. when the percentage of the yellow phosphor (YAG) and the green phosphor (LuAG) is between 0 and 10%, but the temperature exceeds 82.5° C. and reaches approximately 83.2° C. when the percentage of the yellow phosphor (YAG) and the green phosphor (LuAG) is 15%.

Thus, in the case of the yellow phosphor (YAG) and the green phosphor (LuAG), the percentage of the phosphor TOT in the reflective luminous layer AE is preferably 3 to 10% in consideration of the luminance characteristics and the temperature characteristics.

More preferably, the percentage of the phosphor TOT in the reflective luminous layer AE is 3 to 5%.

FIG. 11B is a table showing luminance characteristics and temperature characteristics according to the percentage of a yellow phosphor (Silicate) and a green phosphor (Silicate) in the reflective luminous layer AE.

Referring to FIG. 11B, as the percentage of the yellow phosphor (Silicate) and the green phosphor (Silicate) increases from 0% to 5%, it exhibits an increase in luminance, and as the percentage of the yellow phosphor (Silicate) and the green phosphor (Silicate) increases from 5% to 10%, it exhibits a decrease in luminance.

Meanwhile, the temperature is less than approximately 83° C. when the percentage of the yellow phosphor (Silicate) and the green phosphor (Silicate) is between 3 and 15%, but the temperature exceeds 83° C. and reaches approximately 83.6° C. when the percentage of the yellow phosphor (Silicate) and the green phosphor (Silicate) is 0%.

Thus, in the case of the yellow phosphor (Silicate) and the green phosphor (Silicate), the percentage of the phosphor (TOT) in the reflective luminous layer (AE) is preferably 3 to 10% in consideration of the luminance characteristics and the temperature characteristics.

More preferably, the percentage of the phosphor TOT in the reflective luminous layer AE is 3 to 5%.

FIG. 11C is a graph showing brightness versus wavelength for the phosphor wheel 430y of FIG. 5C including a light-emitting adhesive layer and for the phosphor wheel 430a of FIG. 5D including a reflective luminous layer.

Referring to FIG. 11C, a graph CVx brightness versus wavelength for the phosphor wheel 430y of FIG. 5C including the light-emitting adhesive layer exhibits high brightness in a blue light region of about 450 nm, but, in other wavelength ranges, it exhibits lower brightness than a graph CVa of brightness versus wavelength for the phosphor wheel 430a of FIG. 5D including the reflective luminous layer.

That is, light conversion efficiency is increased in the graph CVa of brightness versus wavelength for the phosphor wheel 430a of FIG. 5D including the reflective luminous layer, so that the graph CVa exhibits high brightness in almost all the wavelength ranges, except in the blue light wavelength region.

FIG. 11D is a table showing the relative efficiency of the graph CVx and the graph CVa.

Referring to FIG. 11D, when the relative efficiency of the graph CVx of brightness versus wavelength for the phosphor wheel 430y of FIG. 5C including the light-emitting adhesive layer is 100%, the graph CVa of brightness versus wavelength for the phosphor wheel 430a of FIG. 5D including the reflective luminous layer has a relative efficiency of 103%, which is increased by 3%.

Thus, the phosphor wheel 430a according to an embodiment of the present disclosure allows light conversion efficiency and thermal conductivity to be improved. In addition, the phosphor wheel 430a enables high-efficiency light output and improved color purity.

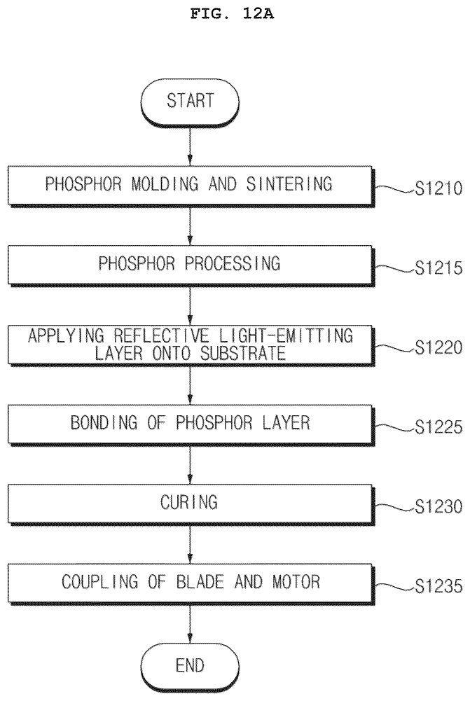

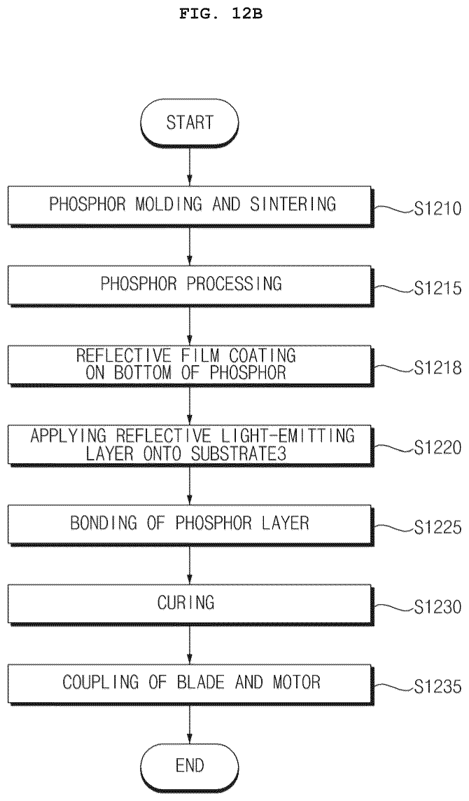

FIGS. 12A and 12B are flowcharts illustrating a method of manufacturing a phosphor wheel according to an embodiment of the present disclosure.

First, referring to FIG. 12A, a phosphor is molded and sintered at a high temperature (S1210).

For example, for molding of the phosphor, nano-raw powders for obtaining a YAG composition (Y3A15012:Ce), which is a yellow phosphor, and a LuAG composition (Lu3A15O12:Ce), which is a green phosphor, are injected and pressed into a ring or segment mold of a desired shape.

For example, a pressure of 8 Ton (about 34 MPa) is applied. In some cases, YAG nano powders may be used for molding of the phosphor.

Meanwhile, for sintering, in order to densify a molded article, high-temperature heat treatment is performed.

Since the temperature varies depending on the desired density, in order to obtain densification of 93 to 98%, the high-temperature heat treatment is carried out in a vacuum atmosphere, ranging from 1500 to 1750° C.

Next, the shape of the ceramic phosphor is processed (S1215). For example, mirror polishing is performed into a desired shape.

Then, a reflective luminous layer AE is applied onto a substrate (S1220). For example, bar coating may be performed on the substrate SB by mixing TiO₂ having a size of 0.2 to 0.5 μm and a phosphor having a size of 0.5 to 15 μm with a resin.

In this case, the reflective luminous layer AE may have a thickness of 80 to 120 μm.

Next, bonding of the processed ceramic phosphor is performed (S1225), and then curing is performed (S1230).

For the formation of a phosphor layer PH on the reflective luminous layer AE, the processed ceramic phosphor is attached onto the printed TiO₂+phosphor layer and is then cured at 150° C. for 2 hours.

Next, coupling of the substrate SB on which the reflective luminous layer AE and the phosphor layer PH are formed, a blade BLD, and a motor 431 are performed (S1235). Thus, the manufacture of a phosphor wheel 430b is complete.

The flowchart of FIG. 12B is the same as the flowchart of FIG. 12A, except that step 1218 (S1218) is further performed between the step 1215 (S1215) and the step 1220 (S1220).

Therefore, the step 1218 (S1218) will be mainly discussed.

After the step 1215 (S1215), for the formation of a highly reflective thin film, reflective film coating may be performed on the bottom of the ceramic phosphor using a high reflective material such as Ag with a thickness of 10 to 5000 nm (S1218). Accordingly, it is possible to improve reflection performance.

The phosphor wheel and the image injection device including the same according to the present disclosure is not limitedly applied to the constructions and methods of the embodiments as previously described; rather, all or some of the embodiments may be selectively combined to achieve various modifications.

It will be apparent that, although the preferred embodiments have been shown and described above, the present disclosure is not limited to the above-described specific embodiments, and various modifications and variations can be made by those skilled in the art without departing from the scope of the present disclosure as defined by the appended claims. Thus, it is intended that the modifications and variations should not be understood independently of the technical idea or perspective of the present disclosure.

1. A phosphor wheel comprising:
a substrate;
a reflective luminous layer disposed on the substrate; and
a phosphor layer disposed on the reflective luminous layer,
wherein the reflective luminous layer comprises:
a resin; and
a phosphor having a higher thermal conductivity than the resin.

2. The phosphor wheel of claim 1, wherein the reflective luminous layer further comprises titanium dioxide (TiO₂), and
wherein the thermal conductivity of the phosphor is higher than a thermal conductivity of the titanium dioxide.

3. The phosphor wheel of claim 1, wherein a percentage of the phosphor in the reflective luminous layer is 3 to 10%.

4. The phosphor wheel of claim 1, wherein the phosphor layer comprises a yellow phosphor layer,
wherein a part of blue light incident on the phosphor layer is incident on the yellow phosphor layer for outputting the yellow light, and
wherein another part of the blue light transmitted through the phosphor layer is incident on a yellow phosphor in the reflective luminous layer for outputting the yellow light.

5. The phosphor wheel of claim 1, wherein the phosphor layer comprises:
a yellow phosphor layer disposed in a first area on the reflective luminous layer; and
a green phosphor layer disposed in a second area on the reflective luminous layer.

6. The phosphor wheel of claim 5, wherein a yellow phosphor is disposed in the reflective luminous layer corresponding to the first area, and
wherein a green phosphor is disposed in the reflective luminous layer corresponding to the second area.

7. The phosphor wheel of claim 5, wherein a size of the first area is greater than a size of the second area.

8. The phosphor wheel of claim 5, further comprising a red phosphor layer disposed in a third area on the reflective luminous layer.

9. The phosphor wheel of claim 8, wherein a red phosphor is disposed in the reflective luminous layer corresponding to the third area.

10. The phosphor wheel of claim 1, further comprising an anti-reflective layer disposed on the phosphor layer.

11. The phosphor wheel of claim 1, further comprising a blade spaced downward from the substrate and rotating about a rotation axis.

12. A phosphor wheel comprising:
a substrate;
a reflective luminous layer disposed on the substrate; and
a phosphor layer disposed on the reflective luminous layer,
wherein the reflective luminous layer comprises a resin, a phosphor, and titanium dioxide (TiO₂).

13. The phosphor wheel of claim 12, wherein the phosphor in the reflective luminous layer has a higher thermal conductivity than the resin.

14. The phosphor wheel of claim 12, wherein the phosphor layer comprises a yellow phosphor layer,
wherein a part of blue light incident on the phosphor layer is incident on the yellow phosphor layer for outputting the yellow light, and
wherein another part of the blue light transmitted through the phosphor layer is incident on a yellow phosphor in the reflective luminous layer for outputting the yellow light.

15. An image projection device comprising:
a light source configured to output blue light; and
a phosphor wheel configured to output light of a plurality of colors based on the incident blue light during rotation of the phosphor wheel,
wherein the phosphor wheel comprises:
a substrate;
a reflective luminous laver disposed on the substrate and
a phosphor layer disposed on the reflective luminous layer,
wherein the reflective luminous layer comprises:
a resin; and
a phosphor having a higher thermal conductivity than the resin.

16. The image projection device of claim 15, further comprising a color filter placed after an output end of the phosphor wheel and configured to sequentially output yellow light, green light, and red light through rotation.

17. The image projection device of claim 15, wherein the color filter is further configured to output blue light.

18. The image projection device of claim 15, wherein the color filter comprises:
a yellow area for yellow light output;
a green area for green light output;
a red area for red light output; and
a blue area for blue light output.

19. The image projection device of claim 18, wherein a size of the yellow area or the blue area is less than a size of the red area or the green area.
